(19) United States
(12) Patent Application Publication
(10) Pub. No.: US 2013/0247569 A1
(43) Pub. Date: Sep. 26, 2013

(54) GEOTHERMAL POWER GENERATION

(71) Applicant: ALSTOM TECHNOLOGY LTD, Baden (CH)

(72) Inventor: Franz Suter, Gebenstorf (CH)

(73) Assignee: ALSTOM Technology Ltd, Baden (CH)

(21) Appl. No.: 13/848,955

(22) Filed: Mar. 22, 2013

(30) Foreign Application Priority Data
Mar. 22, 2012 (EP) 12160862.4

(51) Int. Cl. F03G 7/00

(52) U.S. Cl. CPC F03G 7/00
USPC 60/641.2; 60/641.1

(57) ABSTRACT

A valve arrangement (16) for a geothermal steam turbine generator (10) comprises first and second steam control valves (18, 20) for regulating the supply of steam to the steam turbine generator (10). The first and second steam control valves are arranged in parallel in a steam supply line (24) and the first steam control valve (18) has a smaller fully-open diameter than the second steam control valve (20). The first steam control valve (18) is arranged to regulate the volume flow rate of steam supplied to the steam turbine generator (10) during a speed-control phase, until the steam turbine generator (10) attains a predetermined rotational speed at which it can be connected to an ac electrical system. The second steam control valve (20) is arranged to regulate the volume flow rate of steam supplied to the steam turbine generator (10) during a load-control phase, after the end of the speed-control phase, once the steam turbine generator (10) has attained the predetermined rotational speed and is connected to the ac electrical system.

### TECHNICAL FIELD

The present disclosure relates generally to the field of geothermal power generation and more particularly to the control of a geothermal steam turbine generator. Embodiments of the present disclosure relate in particular to a valve arrangement for controlling the volume flow rate of steam supplied to a geothermal steam turbine generator and/or to a method for controlling such a valve arrangement.

### TECHNICAL BACKGROUND

In a geothermal power plant, geothermal energy is used to heat water to thereby produce steam. The steam is expanded in a geothermal steam turbine generator to generate electricity. The cooled and expanded steam is condensed and returned to source. Types of geothermal power plant include dry steam power plants, flash steam power plants (the most common type of geothermal power plant currently in operation) and binary cycle power plants.

Geothermal power plants normally supply electricity to an ac electrical grid (or other ac electrical system) operating at a particular grid frequency. As such, a geothermal steam turbine generator must be operated at an appropriate rotational speed to enable it to be synchronised with the grid frequency (the so-called synchronisation speed) and, thus, connected to the grid. During start-up of a geothermal power plant, it is therefore necessary to be able to control the rotational speed of the steam turbine generator to enable synchronisation with the grid frequency. Existing geothermal steam power plants do not, however, provide a mechanism for adequately controlling the rotational speed of the steam turbine generator during start-up.

### SUMMARY OF THE DISCLOSURE

According to a first aspect of the present disclosure, there is provided a valve arrangement for controlling steam supply to a geothermal steam turbine coupled to a electric power generator, the valve arrangement comprising first and second steam control valves for regulating the volume flow rate of steam supplied to the steam turbine and a stop valve which located in the steam supply line upstream of the first and second steam control valves, the first and second steam control valves being arranged in parallel in the steam supply line, the first steam control valve having a smaller fully-open diameter than the second steam control valve, wherein:

the steam is supplied at a pressure between 2 bar and 20 bar, the first steam control valve is arranged to regulate the volume flow rate of steam supplied to the steam turbine during a speed-control phase until the steam turbine and the generator attain a predetermined rotational speed at which the steam turbine and the generator can be connected to an electric power grid; and

the second steam control valve is arranged to regulate volume flow rate of steam supplied to the steam turbine during a load-control phase, after the end of the speed-control phase, once the steam turbine and the generator have attained the predetermined rotational speed and is connected to the electric power grid.

According to a second aspect of the present disclosure, there is provided a method for controlling a valve arrangement for a geothermal steam turbine coupled to an electric power generator, the valve arrangement comprising first and second steam control valves for regulating the volume flow rate of steam supplied to the steam turbine generator and a stop valve which located in the steam supply line upstream of the first and second steam control valves, the first and second steam control valves being arranged in parallel in the steam supply line, and the first steam control valve having a smaller fully-open diameter than the second steam control valve, wherein the method comprises:

supplying steam at a pressure between 2 bar and 20 bar to the steam turbine through the first steam control valve during a speed-control phase until the steam turbine attains a predetermined rotational speed at which the steam turbine and the generator can be connected to an electric power grid; and

supplying steam to the steam turbine through the second steam control valve during a load-control phase, after the end of the speed-control phase, once the steam turbine and the generator have attained the predetermined rotational speed and are connected to the electric power grid.

During the speed-control phase, the smaller size of the first steam control valve, as represented by its smaller fully-open diameter, allows a relatively small volume flow rate of steam to be supplied to the steam turbine generator in a controlled manner. This enables the speed of the steam turbine generator to be more carefully controlled so that the predetermined rotational speed needed for connection to the ac electrical system can be more easily attained. The first steam control valve can be used exclusively during the speed-control phase, maintaining the second bigger flow control valve in a shut state.

During the load-control phase, the larger size of the second steam control valve, as represented by its larger fully-open diameter, allows a larger volume flow rate of steam to be supplied to the steam turbine generator so that the power supplied by the steam turbine generator to the ac electrical system (i.e. the generator load) can be varied as necessary.

It will be appreciated that an ac electrical system operates at a predetermined electrical frequency. In order for the steam turbine generator to be properly connected to the ac electrical system, it needs to operate at a synchronisation speed which corresponds to the frequency of the ac electrical system. The synchronisation speed of the steam turbine generator ω (in rpm) is determined using the formula ω=(120*f)/p, where f is the frequency (in Hz) of the ac electrical system and p is the number of poles of the steam turbine generator.

The ac electrical system is typically an ac electrical power transmission grid. In Europe, the predetermined frequency (i.e. the grid frequency) is 50 Hz. For a two-pole steam turbine generator, the required synchronisation speed is, therefore, 3000 rpm.

During the speed-control phase, it is expected that the steam turbine generator may need to be accelerated to a rotational speed which is slightly greater than the required synchronisation speed before synchronisation with the ac electrical system can take place. When synchronisation takes place, the rotational speed of the steam turbine generator then drops slightly so that it is equal to the synchronisation speed. It will, therefore, be appreciated that insofar as this specification refers to a ‘predetermined rotational speed’ at which the steam turbine generator can be connected to an ac electrical system, the predetermined rotational speed may not necessarily be strictly equal to the synchronisation speed.

The valve arrangement may include a closed-loop controller for controlling the operation of the first steam control valve during the speed-control phase based on the rotational speed of the steam turbine generator.

The valve arrangement may include a closed-loop controller for controlling the operation of the second steam control valve during the load-control phase based on the electrical load demanded by the ac electrical system from the steam turbine generator.

The provision of closed-loop controllers enables straightforward automated operation of the steam control valves to regulate the volume flow rate of steam supplied to the steam turbine generator.

The first steam control valve may be arranged to regulate the volume flow rate of steam supplied to the steam turbine generator so that up to 15% of the total available volume flow rate of steam is supplied to the steam turbine generator during the speed-control phase. The first steam control valve may be arranged to regulate the volume flow rate of steam supplied to the steam turbine generator so that between 5% and 8% of the total available volume flow rate of steam is supplied to the steam turbine generator during the speed-control phase.

The second steam control valve may be arranged to regulate the volume flow rate of steam supplied to the steam turbine generator so that between 15% and 100% of the total available volume flow rate of steam is supplied to the steam turbine generator during the load-control phase.

Each of the first and second steam control valves may be a butterfly valve. The stop valve may be also a butterfly valve. Such valves have a robust construction which is well suited to the present application where component reliability is an important consideration.

In some embodiments, the first steam control valve may have a fully-open diameter of 250 mm and the second steam control valve may have a fully-open diameter of 700 mm.

The preferred relative size of the valves can also be characterized by their respective flow characteristics such as the pressure-normalized maximum volume flow, sometimes referred to as Kva and measured in cubic meters per hour. The preferred ratio of Kva for the two valves is in the range of 0.1 to 0.05.

The steam turbine generator may include a two-flow turbine rotor in which the steam enters the steam turbine in the middle of the shaft and exits at each end.

In accordance with the method for controlling the valve arrangement, the operation of the first steam control valve may be controlled during the speed-control phase based on the rotational speed of the steam turbine and the generator. The operation of the second steam control valve may be controlled during the load-control phase based on the electrical load demanded by the electric grid from the steam turbine and the generator.

Steam may be supplied to the steam turbine generator exclusively through the second steam control valve during the load-control phase. The first steam control valve may, therefore, be in the fully closed position during the load-control phase.

The operation of the first steam control valve may be controlled during the speed-control phase so that up to 15% of the total available volume flow rate of steam is supplied to the steam turbine. The operation of the first steam control valve may be controlled during the speed-control phase so that between 5% and 8% of the total available volume flow rate of steam is supplied to the steam turbine.

The operation of the second steam control valve may be controlled during the load-control phase so that between 15% and 100% of the total available volume flow rate of steam is supplied to the steam turbine.

The method may comprise opening the aforesaid stop valve prior to opening the first steam control valve to initiate the speed-control phase. When in the closed position, the stop valve prevents steam supply to both the first and second steam control valves.

### BRIEF DESCRIPTION OF THE DRAWINGS

FIG. 1 is diagrammatic illustration of a geothermal steam turbine and generator system with a single steam inlet and including a valve arrangement according to the present disclosure;

FIG. 2 is a diagrammatic illustration of a geothermal steam turbine and generator system with two steam inlets and including a valve arrangement according to the present disclosure; and

FIG. 3 is a diagrammatic illustration of a geothermal steam turbine and generator system with four steam inlets and including two valve arrangements according to the present disclosure.

### DETAILED DESCRIPTION OF EMBODIMENTS

Embodiments will now be described by way of example only and with reference to the accompanying drawings.

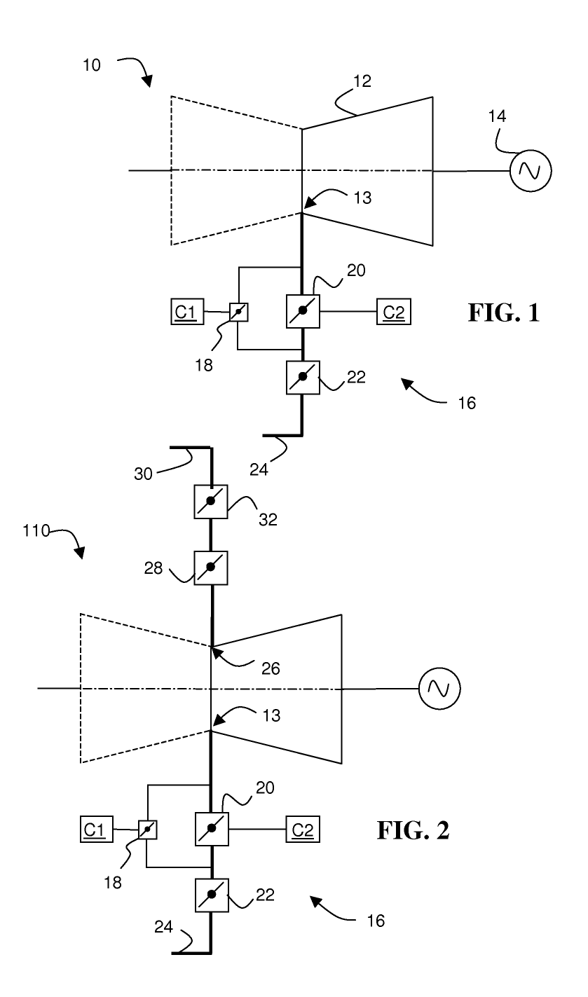

A geothermal steam turbine generator 10, comprising a geothermal steam turbine 12 coupled to an ac electrical generator 14, is illustrated in FIG. 1. The steam turbine generator 10 includes a two-flow turbine rotor in which steam enters the steam turbine 12 at a steam inlet 13 in the middle of the shaft and exits at each end. Steam supplied to the geothermal steam turbine generator 10 is generated using geothermal energy at a relatively low pressure between 2 bar and 20 bar, typically at a pressure around 8 bar. The steam turbine generator 10 is connected in normal operation to an ac electrical grid to supply electricity to the grid at the grid frequency and the rotational speed of the steam turbine generator 10 must, therefore, be synchronised with the grid frequency during normal operation.

A valve arrangement 16 is provided for controlling the flow of steam to the geothermal steam turbine generator 10 to enable its rotational speed to be synchronised with the frequency of the ac electrical grid. The valve arrangement 16 comprises three butterfly valves, namely first and second steam control valves 18, 20 and a stop valve 22. The butterfly valves are all steam-tight when in the closed position. The first and second steam control valves 18, 20 are arranged in parallel in a steam supply line 24 and the stop valve 22 is positioned upstream of the first and second steam control valves 18, 20 in the steam supply line 24. The purpose of the stop valve 22 is to prevent or allow the flow of steam to the first and second steam control valves 18, 20, whilst the purpose of the first and second steam control valves 18, 20 is to regulate the volume flow rate of steam supplied to the steam turbine generator 10.

The first steam control valve 18 has a smaller fully open diameter than the second steam control valve 20. In one embodiment, the first steam control valve 18 has a fully-open diameter of 250 mm whilst the second steam control valve 20 has a fully-open diameter of 700 mm. The first, smaller, steam control valve 18 is used to control the rotational speed of the steam turbine generator 10 during a speed-control phase, prior to connection of the steam turbine generator 10 to the ac electrical grid, whilst the second steam control valve 20 is used to control the power output of the steam turbine generator 10 during a load-control phase, after to connection of the steam turbine generator 10 to the ac electrical grid when its rotational speed remains constant.

In more detail, the first and second steam control valves 18, 20 and the stop valve 22 are all initially in the closed position prior to start-up of the steam turbine generator 10. Once steam at the required pressure and temperature is available for supply to the steam turbine generator 10, the stop valve 22 is opened. The first steam control valve 18 is then gradually opened to provide an increasing volume flow rate of steam to the steam turbine generator 10, the steam being expanded in the steam turbine 12 to thereby accelerate the rotor of the steam turbine generator 10. Typically, between 5% and 10% of the total available volume flow rate of steam can be supplied to the steam turbine generator 10 via the first steam control valve 18 during the speed-control phase.

A closed-loop controller C1 controls a first fail-safe actuator associated with the first steam control valve 18 to control the extent of opening of the first steam control valve 18, and, hence, to regulate the volume flow rate of steam supplied to the steam turbine generator 10, based on the rotational speed of the steam turbine generator 10. The fail-safe actuator can be for example a hydraulically operated actuator with a spring mechanism closing the valve 18 in case of a power failure.

Typically the first control valve would not be operated close to its maximum flow rate to preserve controlling capacity. Once the closed-loop controller C1 senses that the steam turbine generator 10 has attained a predetermined rotational speed which is necessary to enable it to be connected to the ac electrical grid, the first steam control valve 18 is closed and the second steam control valve 20 is opened to maintain the necessary steam supply to the steam turbine generator 10. As discussed above, it should be noted that the predetermined speed which is necessary to enable the steam turbine generator 10 to be connected to the ac electrical grid may be slightly greater than the synchronisation speed. Once connected to the ac electrical grid, however, the steam turbine generator 10 rotates at the synchronisation speed which is appropriate for the grid frequency and supplies a minimum electrical load to the ac electrical grid. Where the grid frequency is 50 Hz and the steam turbine generator 10 is a two-pole machine, the synchronisation speed is 3000 rpm.

Once the steam turbine generator 10 is connected to the ac electrical grid, a closed-loop controller C2 controls a second fail-safe actuator associated with the second steam control valve 20 to control the extent of opening of the second steam control valve 20 and, hence, to regulate the volume flow rate of steam supplied to the steam turbine generator 10, based on the electrical power demanded by the ac electrical grid. The second fail-safe actuator can be of the same type as fail-safe actuator associated with the first control valve 18.

When more electrical power needs to be supplied to the ac electrical grid, the closed-loop controller C2 increases the extent of opening the second steam control valve 20 to increase the volume flow rate of steam supplied to the steam turbine generator 10 and thereby increase the generated electrical load. Similarly, when the electrical power demanded by the ac electrical grid decreases, the closed-loop controller C2 decreases the extent of opening the second steam control valve 20 to decrease the volume flow rate of steam supplied to the steam turbine generator 10 and thereby decrease the generated electrical load. Typically, between 15% and 100% of the total available volume flow rate of steam can be supplied to the steam turbine generator 10 via the second steam control valve 20 during the load-control phase. The controller C1 and C2 can be implemented as a single unit.

Depending on the total flow, the first steam control valve may have a fully-open diameter of 250 mm and the second steam control valve may have a fully-open diameter of 700 mm. In terms of pressure-normalized maximum volume flow, sometimes referred to as Kva and measured in cubic meters per hour the first control valve 18 can for example have a Kva of 1870 m**3/h while the second control valve 20 can for example have a Kva of over 25000 m**3/h. The resulting ratios of Kvas are typically in the range of 1:10 to 1:20 and such ratios may be useful even in cases where the second control valve 20 is effectively replaced by two or more valves as described in the following examples.

Referring now to FIG. 2, there is shown a geothermal steam turbine generator 110 with two steam inlets 13, 26. The geothermal steam turbine generator 110 is similar to the steam turbine generator 10 illustrated in FIG. 1 and corresponding components are, therefore, identified using corresponding reference numerals.

Like the geothermal steam turbine generator 10, the geothermal steam turbine generator 110 includes a valve arrangement 16 for controlling the supply of steam to the steam turbine generator 110. The steam turbine generator 110 additionally includes a further steam control valve 28 positioned in a steam supply line 30 for regulating the volume flow rate of steam supplied to the steam turbine generator 110 during the load-control phase. A stop valve 32 is positioned in the steam supply line 30 upstream of the steam control valve 28. The steam control valve 28 and the stop valve 32 are both butterfly valves.

During the speed-control phase, the valve arrangement 16 is operated in the manner described above with reference to FIG. 1 to increase the rotational speed of the steam turbine generator 110 until it attains a predetermined speed at which connection to the ac electrical grid can take place. During the speed control phase, the stop valve 32 is closed to prevent the supply of steam to the steam turbine generator 110 via the steam control valve 28 and hence steam inlet 26.

Once the steam turbine generator 110 is connected to the ac electrical grid and rotating at the synchronisation speed, the first steam control valve 18 is closed as described above and the second steam control valve 20 is opened. Either at the same time or subsequently depending on the power demanded by the ac electrical grid, the closed loop controller C2 may open the steam control valve 28 to increase the volume flow rate of steam supplied to the steam turbine generator 110. Steam can, thus, be supplied simultaneously via both steam inlets 13, 26 during the load-control phase. The stop valve 32 must, of course, be opened before steam can be supplied via the steam control valve 28.

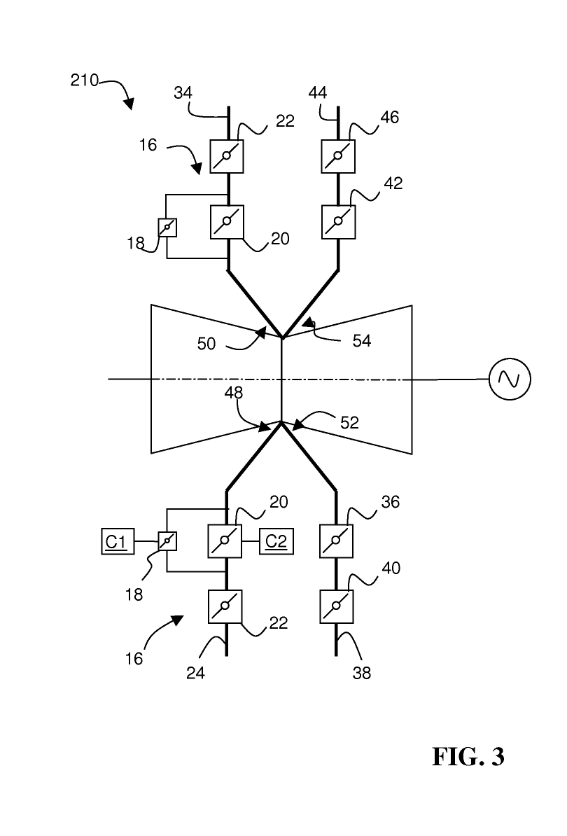

Referring now to FIG. 3, there is shown a geothermal steam turbine generator 210 with four steam inlets 48, 50, 52, 54. The geothermal steam turbine generator 210 is similar to the steam turbine generator 10 illustrated in FIG. 1 and corresponding components are, therefore, identified using corresponding reference numerals.

The geothermal steam turbine generator 210 includes two valve arrangements 16 as described above for controlling the supply of steam to the steam turbine generator 210 each positioned in a steam supply line 24, 34 connected respectively to one of the steam inlets 48, 50. The steam turbine generator 210 additionally includes a further steam control valve 36, positioned in a steam supply line 38 connected to a steam inlet 52, for regulating the volume flow rate of steam supplied to the steam turbine generator 210 during the load-control phase. A stop valve 40 is positioned in the steam supply line 38 upstream of the steam control valve 36. The steam control valve 36 and the stop valve 40 are both butterfly valves. The steam turbine generator 210 also includes a further steam control valve 42, positioned in a steam supply line 44 connected to the steam inlet 54, for regulating the volume flow rate of steam supplied to the steam turbine generator 210 during the load-control phase. A stop valve 46 is positioned in the steam supply line 44 upstream of the steam control valve 42. The steam control valve 42 and the stop valve 46 are both butterfly valves.

During the speed-control phase, one or both of the valve arrangements 16 are operated in the manner described above with reference to FIG. 1 to increase the rotational speed of the steam turbine generator 210 until it attains a predetermined speed at which connection to the ac electrical grid can take place. During the speed control phase, the stop valves 40, 46 are both in the closed position to prevent the supply of steam to the steam turbine generator 210 via the steam control valves 36, 42 and steam inlets 52, 54.

Once the steam turbine generator 210 is connected to the ac electrical grid and rotating at the synchronisation speed, the first steam control valve 18 of each valve arrangement 16 can be closed as described above and the second steam control valve 20 of one or both valve arrangements 16 can be opened. Either at the same time or subsequently depending on the power demanded by the ac electrical grid, the closed loop controller C2 may open one or both of the steam control valves 36, 42 to increase the volume flow rate of steam supplied to the steam turbine generator 210. The stop valves 40, 46 must, of course, be opened before steam can be supplied via the respective steam control valves 36, 42.

The arrangement of FIG. 3 is particularly suited to higher volume steam flow rates, for example in excess of 60 m3/sec.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments. Each feature disclosed in the specification, including the claims and drawings, may be replaced by alternative features serving the same, equivalent or similar purposes, unless expressly stated otherwise.

For example, steam turbine configurations other than the illustrated two-flow rotor configuration may be employed.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. Geothermal steam turbine coupled to a electric power generator, the valve arrangement comprising first and second steam control valves for regulating the volume flow rate of steam supplied to the steam turbine and a stop valve which located in the steam supply line upstream of the first and second steam control valves, the first and second steam control valves being arranged in parallel in the steam supply line and a stop valve (22) located in the steam supply line (24) upstream of the first and second steam control valves (18, 20), the first steam control valve having a smaller fully-open diameter than the second steam control valve, wherein: the steam is supplied at a pressure between 2 bar and 20 bar, the first steam control valve is arranged to regulate the volume flow rate of steam supplied to the steam turbine during a speed-control phase until the steam turbine and the generator attain a predetermined rotational speed at which the steam turbine and the generator can be connected to an electrical power grid; and the second steam control valve is arranged to regulate volume flow rate of steam supplied to the steam turbine during a load-control phase, after the end of the speed-control phase, once the steam turbine and the generator have attained the predetermined rotational speed and is connected to the electrical power gridA valve arrangement (16) for controlling steam supply to a geothermal steam turbine (10, 12, 110, 210) coupled to an electric generator (14), the valve arrangement (16) comprising first and second steam control valves (18, 20) for regulating the volume flow rate of steam supplied to the steam turbine and a stop valve (22) located in a steam supply line (24) upstream of the first and second steam control valves (18, 20), the first and second steam control valves (18, 20) being arranged in parallel in the steam supply line (24), the first steam control valve (18) being of smaller flow capacity than the second steam control valve (20), wherein: the steam is supplied at a pressure between 2 bar and 20 bar the first steam control valve (18) is arranged to regulate the volume flow rate of steam supplied to the steam turbine during a speed-control phase until the steam turbine and the generator attain a predetermined rotational speed at which the steam turbine and generator can be connected to an electric power grid; and the second steam control valve (20) is arranged to regulate the volume flow rate of steam supplied to the steam turbine during a load-control phase, after the end of the speed-control phase, once the steam turbine and the generator have attained the predetermined rotational speed and is connected to the electric power grid.

2. A valve arrangement according to claim 1, wherein the valve arrangement includes a closed-loop controller and a first fail-safe actuator (C1) for controlling the operation of the first steam control valve (18) during the speed-control phase based on the rotational speed of the steam turbine generator.

3. A valve arrangement according to claim 1, wherein the valve arrangement includes a closed-loop controller and a first fail-safe actuator (C2) for controlling the operation of the second steam control valve (20) during the load-control phase based on the electrical load demanded by the electric power grid from the steam turbine and the generator.

4. A valve arrangement according to claim 1, wherein the first steam control valve (18) is arranged to regulate the volume flow rate of steam supplied to the steam turbine so that up to 15% of the total load, and preferably between 5% and 8% of the total available volume flow rate of steam, is supplied to the steam turbine during the speed-control phase.

5. A valve arrangement according to claim 1, wherein the second steam control valve (20) is arranged to regulate the volume flow rate of steam supplied to the steam turbine generator so that between 15% and 100% of the total load is supplied to the steam turbine during the load-control phase.

6. A valve arrangement according to claim 1, wherein each of the first and second steam control valves (18, 20) is a butterfly valve.

7. A valve arrangement according to claim 1, wherein the first steam control valve (18) and the second steam control valve (20) have a ratio of their respective maximal normalized flow rate in the range of 0.1 to 0.05.

8. A valve arrangement according to claim 1, wherein the first steam control valve (18) has a fully-open diameter of 250 mm and the second steam control valve (20) has a fully-open diameter of 700 mm.

9. A method for controlling a valve arrangement (16) for a geothermal steam turbine (10, 12, 110, 210) coupled to a generator (14), the valve arrangement (16) comprising first and second steam control valves (18, 20) for regulating the volume flow rate of steam supplied to the steam turbine generator, the first and second steam control valves (18, 20) being arranged in parallel in a steam supply line (24) and a stop valve (22) located in the steam supply line (24) upstream of the first and second steam control valves (18, 20), and the first steam control valve (18) having a smaller flow capacity than the second steam control valve (20), wherein the method comprises: supplying steam to the steam turbine at a pressure of 2 to 20 bar through the first steam control valve (18) during a speed-control phase until the steam turbine generator attains a predetermined rotational speed at which the steam turbine and the generator can be connected to an electric power grid; and supplying steam to the steam turbine generator through the second steam control valve (20) during a load-control phase, after the end of the speed-control phase, once the steam turbine generator has attained the predetermined rotational speed and is connected to the electric power grid.

10. A method according to claim 9, wherein the operation of the first steam control valve (18) is controlled during the speed-control phase based on the rotational speed of the steam turbine and the generator.

11. A method according to claim 9, wherein the operation of the second steam control valve (20) is controlled during the load-control phase based on the electrical load demanded by the electric power grid from the steam turbine and the generator.

12. A method according to claim 9, wherein steam is supplied to the steam turbine generator exclusively through the first steam control valve (18) during the speed-control phase.

13. A method according to claim 9, wherein the operation of the first steam control valve (18) is controlled during the speed-control phase so that up to 15% of the total load, and preferably between 5% and 8% of the total available volume flow rate of steam, is supplied to the steam turbine.

14. A method according to claim 9, wherein the operation of the second steam control valve (20) is controlled during the load-control phase so that between 15% and 100% of the total load is supplied to the steam turbine.
